(19) United States
(12) Patent Application Publication
(10) Pub. No.: US 2006/0171614 A1
(43) Pub. Date: Aug. 3, 2006

(54) Fluid dynamic bearing device, spindle motor and disk drive

(75) Inventors: Naoko Kashiwa, Minami-ku (JP); Makoto Nakanishi, Minami-ku (JP); Takayuki Okada, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/334,482

(22) Filed: Jan. 19, 2006

(30) Foreign Application Priority Data
Jan. 20, 2005 (JP) 2005-012495
Jan. 13, 2006 (JP) 2006-005450

(51) Int. Cl. F16C 32/06

(52) U.S. Cl. 384/100

(57) ABSTRACT

A fluid dynamic bearing device, a spindle motor and a disk drive apparatus are disclosed. A highly accurate fluid dynamic bearing member of the fluid dynamic bearing device can be formed of a free-cutting stainless steel composition easy to cut or otherwise machine, while at the same time preventing the leakage and scattering of a lubricating fluid. At least one of the two bearing surfaces formed with a dynamic pressure generating groove of the fluid dynamic bearing mechanism is formed of the free-cutting stainless steel composition. The average short diameter of the inclusion particles on the ground surface of the free-cutting stainless steel composition is between 1 μm and 10 μm inclusive, and the average long diameter thereof is between 1 μm and 30 μm inclusive.

### BACKGROUND OF THE INVENTION

1. Field of the Invention

This invention relates to a fluid dynamic bearing device for rotatably supporting a rotary member on a fixed member using a fluid dynamic bearing, a spindle motor and a disk drive apparatus.

2. Description of the Related Art

In recent years, efforts have been made variously to develop a fluid dynamic bearing device for rotatably supporting various high-speed rotary members including a polygon mirror, a magnetic disk and an optical disk. The fluid dynamic bearing device includes a dynamic bearing surface on the rotary member side and a dynamic bearing surface on the fixed member side arranged radially or axially in opposed relation to each other with a predetermined gap therebetween, and a dynamic bearing portion is formed in the gap. A dynamic pressure generating groove is formed on at least one of the opposed dynamic bearing surfaces. A lubricating fluid such as air or oil is injected into the dynamic bearing portion. During the rotation, the pumping action of the dynamic pressure generating groove applies a pressure, so that the rotary member is rotatably supported afloat with respect to the fixed member by the dynamic pressure of the lubricating fluid.

In various rotary member driving units employing this fluid dynamic bearing device, a high parts machining accuracy is required, and to meet this requirement, a material of stainless steel, copper or aluminum is often used. Among these materials, stainless steel is used most often for its high abrasive resistance as compared with a copper material. Of all the stainless steel materials, the free-cutting stainless steel high in machinability finds especially many applications.

The fluid dynamic bearing device has recently been reduced in size and thickness rapidly, and each bearing component member has become less and less thick to meet the requirement for reduction in the size and thickness of the device. The reduced thickness of a member may result scattering the lubricating fluid or, especially, the lubricating oil due to the partial pressure increase in the sliding part of the bearing.

One probable reason for this phenomenon is described below.

Assume that the free-cutting stainless steel easy to cut is used and the electrochemical machining is carried out after cutting. The inclusions generating the free-cutting performance which are located in spots on the surface of the stainless steel material have a low solubility in the electro-chemical machining solution, and therefore remain as protrusions several to several tens of microns in size without being machined. These protrusions become particles and intrude into the sliding part of the bearing members, thereby often posing a serious lubrication problem. For this reason, the protrusions are melted off using an acid solvent or otherwise removed by a chemical process. Once the protrusions are removed, the inclusions on the surface of the stainless steel material are solved away and therefore voids are formed.

It has been found that in the case where the voids are formed through the thin parts of a member, the lubricating oil leaks out of the voids and scattered during the relative rotation of the fluid dynamic bearing device. Also, in the case where the voids come to communicate with each other, the size thereof is increased to such an extent that the lubricating oil further leaks out and scatters. The inclusions causing the voids are formed in the manner described below.

Generally, the stainless steel material used for the fluid dynamic bearing device, after being melted in the melting furnace, is cooled into a steel ingot, and through the heat or cold rolling process, formed into a rod. The rod is cut or otherwise machined into an intended shape. The inclusions are extended by the rolling process, and therefore the size of the inclusions (i.e. the size of the voids) is determined by the rolling process.

On the other hand, the diameter of the rod is determined in accordance with the size (diameter) of the intended member. The stainless steel material is drawn to the diameter of the intended member by the rolling process from a steel ingot of a predetermined size. In fabricating a small member such as a fluid bearing device, therefore, a rod correspondingly smaller in diameter is drawn into an elongate form from the steel ingot. In the process, the inclusions in the elongate drawn rod are also drawn in the same direction.

The rod of stainless steel spotted with the drawn inclusions is cut in the direction along the thickness perpendicular to the drawing direction into the required thickness of a member of the fluid dynamic bearing device. Then, the inclusions are removed, and voids the same in size as the inclusions are formed. The more the inclusions or the longer the axial length thereof, therefore, the larger and longer the voids formed, resulting in the scattering of the lubricating oil as described above.

### SUMMARY OF THE INVENTION

According to this invention, the free-cutting stainless steel controlled to contain the optimum number and size of the inclusions for the fluid dynamic bearing is used for the fluid dynamic bearing device. In the absence of an unnecessarily elongate inclusion, therefore, no through hole or pinhole is formed by the thinning process.

The fluid dynamic bearing device often has such a configuration that a local dynamic pressure is generated in the lubricating fluid or the lubricating fluid is circulated in the bearing under pressure. The use of the optimized free-cutting stainless steel prevents the leakage of the lubricating fluid through pinholes or through holes.

The advantage of the invention is conspicuous especially in the application to a small-sized fluid dynamic bearing device or a spindle motor having thin component members.

According to this invention, the desired distribution of the inclusions is successfully realized with a greater ease by appropriately limiting the components of the free-cutting stainless steel. Especially, by containing Ti together with Mn and Cr in sulfide inclusions, the inclusions are greatly reduced in size and the leakage of the lubricating fluid is avoided.

In the case where the Ti content is further increased to form inclusions having a Ti sulfide or a Ti nitride as a main component, on the other hand, the cutting performance is adversely affected in spite of a further reduced size. According to the invention, the machinability is maintained by appropriating controlling the Ti content. In the fluid dynamic bearing device according to the invention, therefore, the lubricating fluid is hard to leak and the machining operation for device fabrication can be carried out easily with a high productivity.

According to this invention, the free-cutting stainless steel composition can be produced by the continuous casting process, and therefore the production cost is further reduced.

Generally, the continuous casting process is executed in such a manner that melted steel is injected from one side of a water-cooled mold and cast iron is drawn from the other side. Impurities such as S, therefore, are liable to be deposited in the neighborhood of the central part of the cast iron and large inclusions of sulfide are liable to be formed. In the case where the direction in which the cast iron is drawn coincides with the direction of rolling, the inclusions extended long in the direction of rolling are formed more easily. In view of this disadvantage, a small ingot about 50 kg in weight is sometimes cast without using the continuous casting process to prevent large inclusions from being formed. The Ti—Cr—S inclusions are comparatively less affected by these casting conditions, and even when fabricated by the continuous casting process, hardly produce large inclusions. In the case where the Mn—Cr—S inclusions more liable to be formed as large inclusions are the sole inclusions, the continuous casting process is not desirable especially for the small-sized fluid dynamic bearing device. The coexistence of the Mn—Cr—S inclusions with the Ti—Cr—S inclusions, however, suppresses the formation of large inclusions and makes it possible to use the continuous casting process.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a longitudinal sectional view schematically showing a disk drive apparatus 100 according to the invention.

FIG. 2 is a diagram showing a spindle motor according to an embodiment of the invention.

FIG. 3 shows the result of observing a stainless steel member of the invention steel product A under microscope.

FIG. 4 shows the result of observing a stainless steel member of the invention steel product A under microscope.

FIG. 5 shows the result of observing a stainless steel member of the comparison steel product B under microscope.

FIG. 6 shows the result of observing a stainless steel member of the comparison steel product B under microscope.

FIG. 7 shows the result of observing a stainless steel member of the comparison steel product C under microscope.

FIG. 8 shows the result of observing a stainless steel member of the comparison steel product C under microscope.

FIG. 9 shows the result of analyzing the elements of the components of an elongate inclusion in a stainless steel member of the invention steel product A.

FIG. 10 shows the result of analyzing the elements of the components of a spherical inclusion in a stainless steel member of the invention steel product A.

FIG. 11 shows the result of analyzing the elements of the components of an inclusion in a stainless steel member of the comparison steel product B.

FIG. 12 shows the result of analyzing the elements of the components of an inclusion in a stainless steel member of the comparison steel product C.

FIG. 13 is a diagram showing the machinability evaluation of each stainless steel member.

FIG. 14 shows the result of a helium leak test conducted on a stainless steel member of the invention steel product A and a stainless steel member of the comparison steel product B not processed.

FIG. 15 shows the result of a helium leak test conducted on a stainless steel member of the invention steel product A and a stainless steel member of the comparison steel product B after the surface passivation process.

FIG. 16 is a diagram for explaining a method of measuring the size and length of an inclusion existing in the stainless steel member of the invention steel product A and a stainless steel member of the comparison steel material B.

FIG. 17 shows the result of measuring the size in the rolling direction (Y direction) of an inclusion existing in a stainless steel member of the invention steel product A.

FIG. 18 shows the result of measuring the size in the direction (X direction) perpendicular to the rolling direction of an inclusion existing in a stainless steel member of the invention steel product A.

FIG. 19 shows the result of measuring the size in the rolling direction (Y direction) of an inclusion existing in a stainless steel member of the comparison steel product B.

FIG. 20 shows the result of measuring the size in the direction (X direction) perpendicular to the rolling direction of an inclusion existing in a stainless steel member of the comparison steel product B.

### DETAILED DESCRIPTION OF THE INVENTION

A fluid dynamic bearing device according to each embodiment of the invention is explained below reference to the drawings, together with a spindle motor using the device. This invention is not limited to the embodiments described below.

<Configuration of Disk Drive Apparatus>

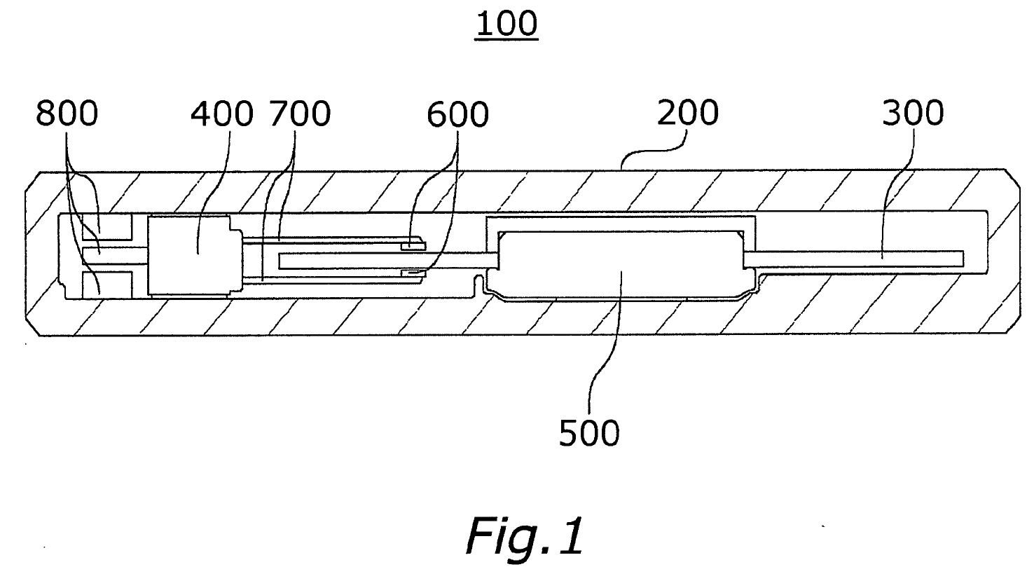

FIG. 1 is a longitudinal sectional view schematically showing a disk drive apparatus 100 according to an embodiment of the invention. This disk drive apparatus 100 is a small-sized thin hard disk drive, for example, for rotating a small recording disk such as a small hard disk having the outer diameter of not more than 2.5 inches (in particular, not more than 1 inch).

The component parts of the disk drive apparatus 100 are accommodated in a housing 200 and mainly include a recording disk 300, a magnetic head moving mechanism 400 and a spindle motor 500.

The recording disk 300 is a discal member having a magnetic recording layer of a magnetic material capable of recording information by magnetism. A small recording disk 300 having the diameter of 2.5 inches is illustrated.

The magnetic head moving mechanism 400 is for reading and writing information from and into the recording disk 300, and includes a pair of magnetic heads 600, a pair of arms 700 and an actuator 800. The magnetic heads 600 are for recording information on the magnetic recording layer of the recording disk 300 on the one hand and reproducing information recorded in the magnetic recording layer on the other hand. The magnetic heads 600 are arranged at an end of the arms 700 in proximity to the two surfaces of the recording disk 300. The arms 700 are for supporting the magnetic heads 600. The actuator 800 is for moving the magnetic heads 600 on the recording disk 300 and support the other end of the arms 700. The arms 700 are swiveled by the actuator 800, so that the magnetic heads 600 can be moved to the desired position on the recording disk 300.

The spindle motor 500 is for rotationally driving the recording disk 300 and has a configuration described below.

<Configuration of Spindle Motor>

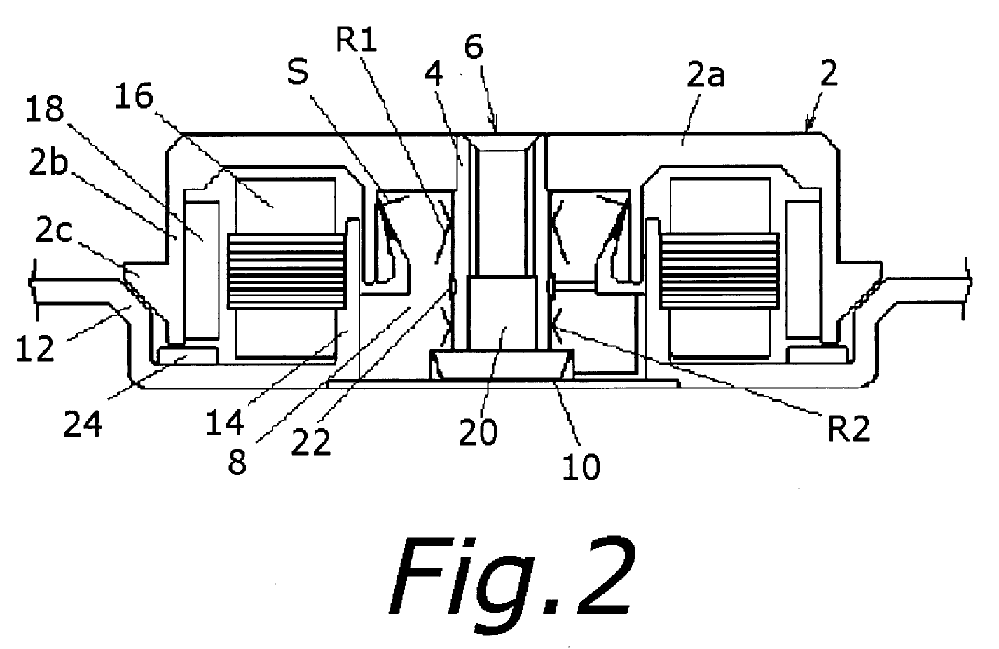

The spindle motor shown in FIG. 2 comprises a rotor hub 2 having a substantially discal upper wall 2a (ceiling plate) and a cylindrical peripheral wall 2b drooped down from the outer peripheral edge of the upper wall 2a, a rotor 6 having a shaft 4 with an end thereof fixedly fitted on the central part of the upper wall 2a of the rotor hub 2, a hollow cylindrical sleeve 8 for rotatably supporting the shaft 4, a cover member 10 for closing the lower part of the sleeve 8, and a bracket 12 integrally formed with a cylindrical portion 12 for holding the sleeve 8.

A stator 16 is arranged on the outer periphery of the cylindrical portion 14 of the bracket 12. A rotor magnet 18 is fixed on the inner peripheral surface of the peripheral wall 2b of the rotor hub 2 so as to oppose the stator 16 with a gap therebetween.

A flange-like disk mounting portion 2c for mounting the recording disk (FIG. 1) thereon is arranged on the outer peripheral surface of the peripheral wall 2b of the rotor hub 2. The part of the shaft 4 nearer to the cover member 10 of the sleeve 8 is stopped by a pin 20 to prevent the rotor 6 from coming off.

A thrust bearing S for generating the flying force of the rotor 6 is formed between the bottom surface of the rotor hub 2 and the upper end surface of the sleeve 8. Also, an upper radial bearing R1 and a lower radial bearing R2 for aligning and preventing the tilting of the rotor 6 are arranged, through an air medium 22 communicating with the atmosphere, between the inner peripheral surface of the sleeve 8 and the outer peripheral surface of the shaft 4 arranged integrally with the rotor hub 2.

An annular member 24 of a ferromagnetic material such as stainless steel is arranged at a position in axially opposed relation to the rotor magnet 14 of the base member 12. The supporting force in such a direction as to suppress the flying of the rotor 6 is produced by the magnetic attraction force exerted between the rotor magnet 14 and the annular member 24. The flying force for the rotor 6 due to the dynamic pressure generated by the thrust bearing S and the upper radial bearing R1 is balanced with the magnetic attraction force exerted between the rotor magnet 18 and the annular member 24 thereby to support the axial load imposed on the rotor 6.

The rotor hub 2, the shaft 4, the sleeve 8, the cover member 10, the base member 12 and the pin 20 making up the component parts of the motor are formed of stainless steel of high free-cutting performance. The machining operation is often conducted in such a manner that the direction of rolling is coincident with the axial direction (shaft direction). In further promoting the reduction in size and thickness, therefore, the materials of these component members are studied as described below.

First, an experiment is conducted as described below on the stainless steel products according to this invention. The stainless steel having the composition (percentage by mass) shown in Table 1 is melted and continuously cast to produce a bloom. The bloom has the cross section 180 mm×180 mm in size. This bloom is heated to 1050 to 1100° C., and after heat forging and rolling, machined into a round bar of 20 mm. In the process, the steel material is extended along the length of the bloom, and the total elongation percentage during the process from the bloom to the round bar is about 100. The round bar is heated for another one hour at 750° C., cooled by air and used for various tests.

TABLE 1
(wt %)

| | Ingredient | | | | | | | | | | |
|---|---|---|---|---|---|---|---|---|---|---|---|
| | C | Si | Mn | P | S | Cu | Ni | Cr | Pb | Ti | N |
| Invention steel | 0.03 | 1.01 | 0.30 | 0.019 | 0.38 | 0.02 | <0.01 | 22.1 | <0.01 | 0.35 | 0.007 |
| product A | | | | | | | | | | | |
| Comparison steel | 0.02 | 0.36 | 0.46 | 0.022 | 0.24 | 0.02 | <0.01 | 19.2 | 0.22 | 0.035 | 0.008 |
| product B | | | | | | | | | | | |
| Comparison steel | 0.02 | 0.98 | 0.33 | 0.017 | 0.19 | 0.01 | <0.01 | 19.0 | <0.01 | 0.63 | 0.006 |
| product C | | | | | | | | | | | |

<0.01, <0.001: Below the limit of analysis

The feature of the composition of the stainless steel products shown in Table 1 is that Ti (titanium) is added to the invention steel product A and the comparison steel product C, and Pb (lead) is contained in the comparison steel product B. The study is made from various angles using these three types of stainless steel products.

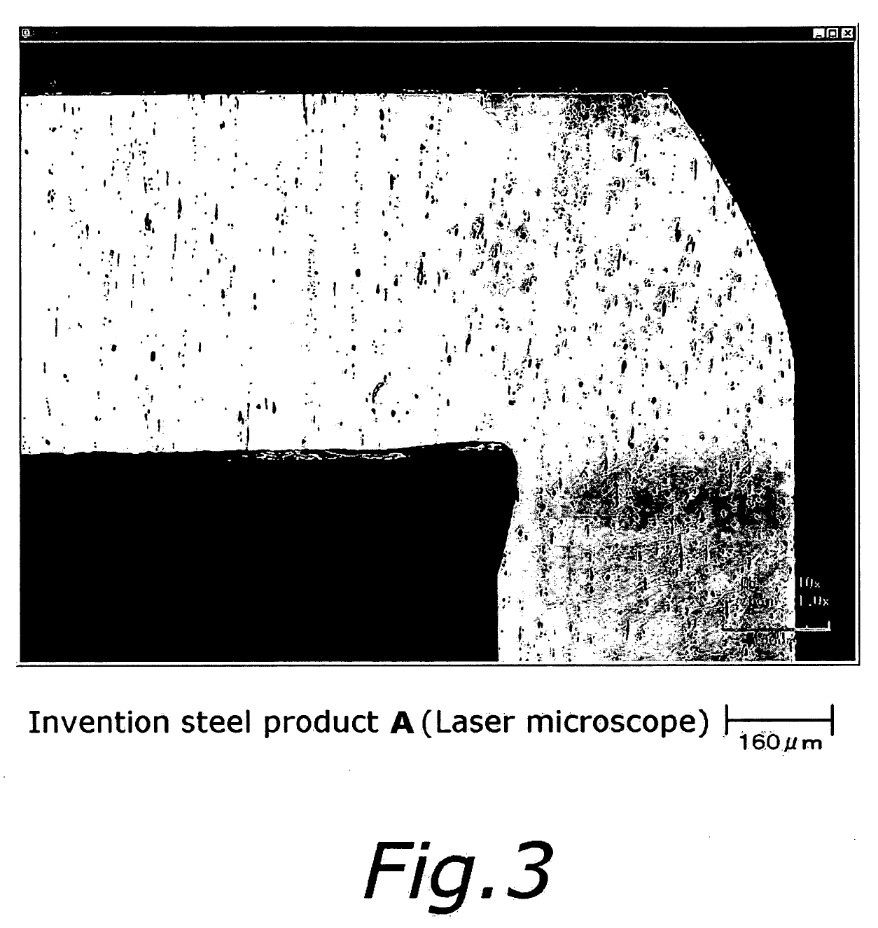

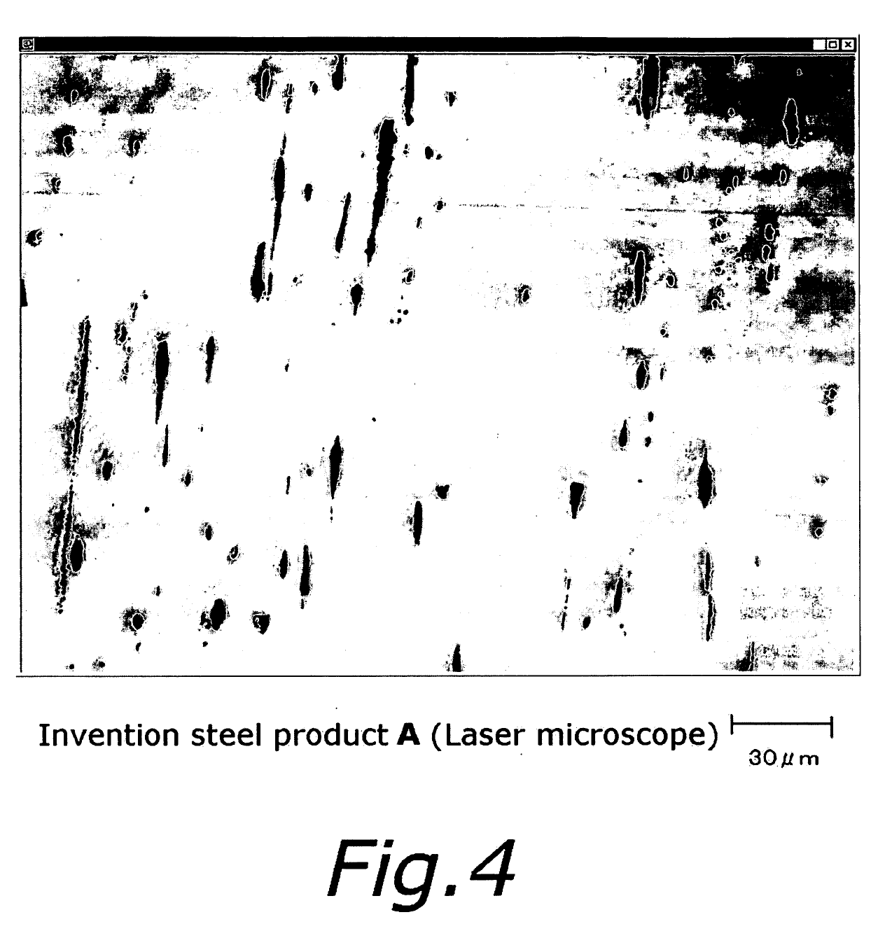

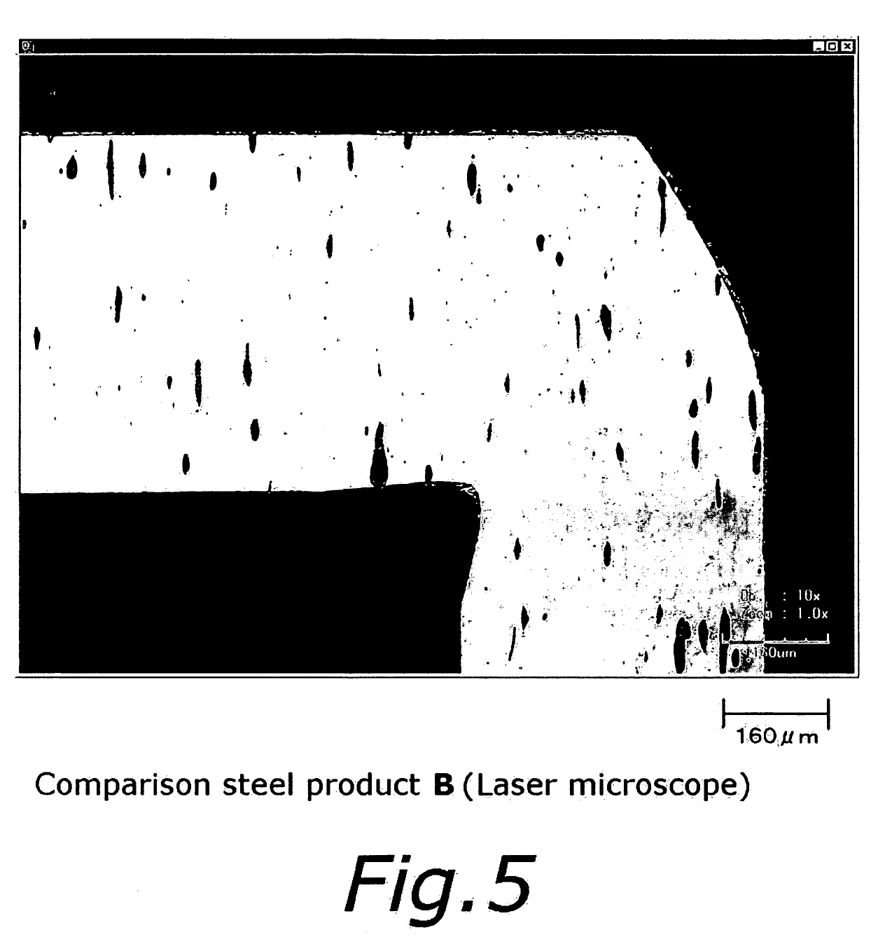

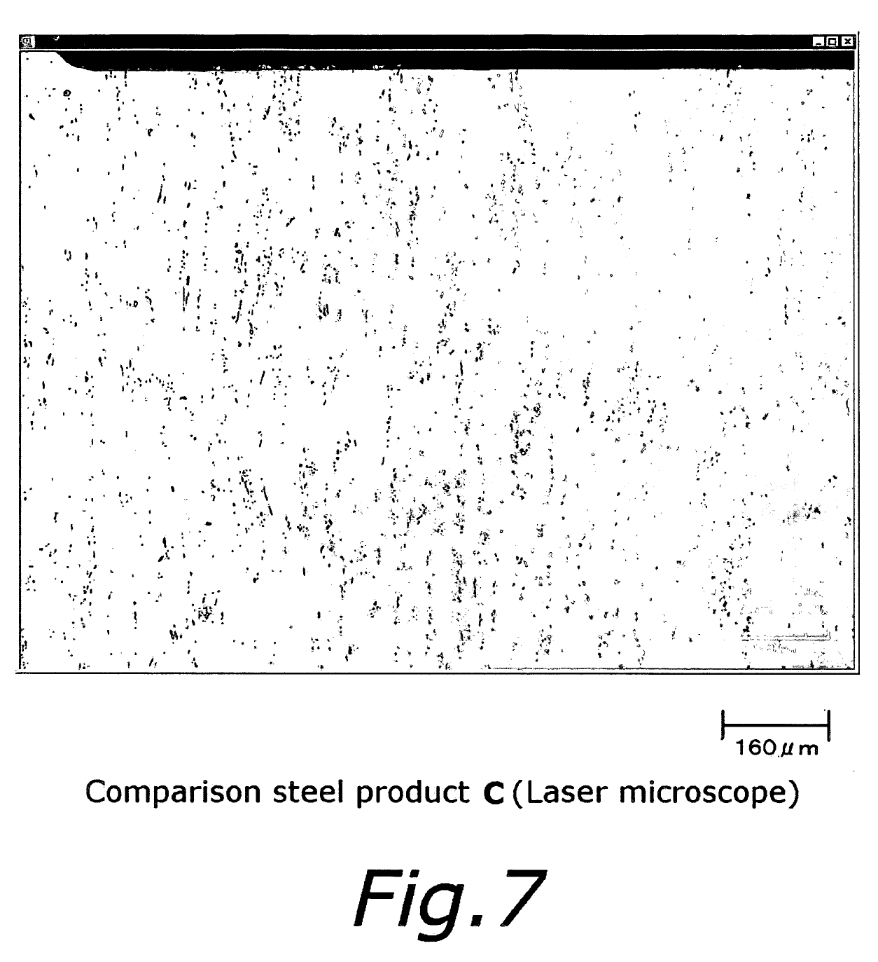

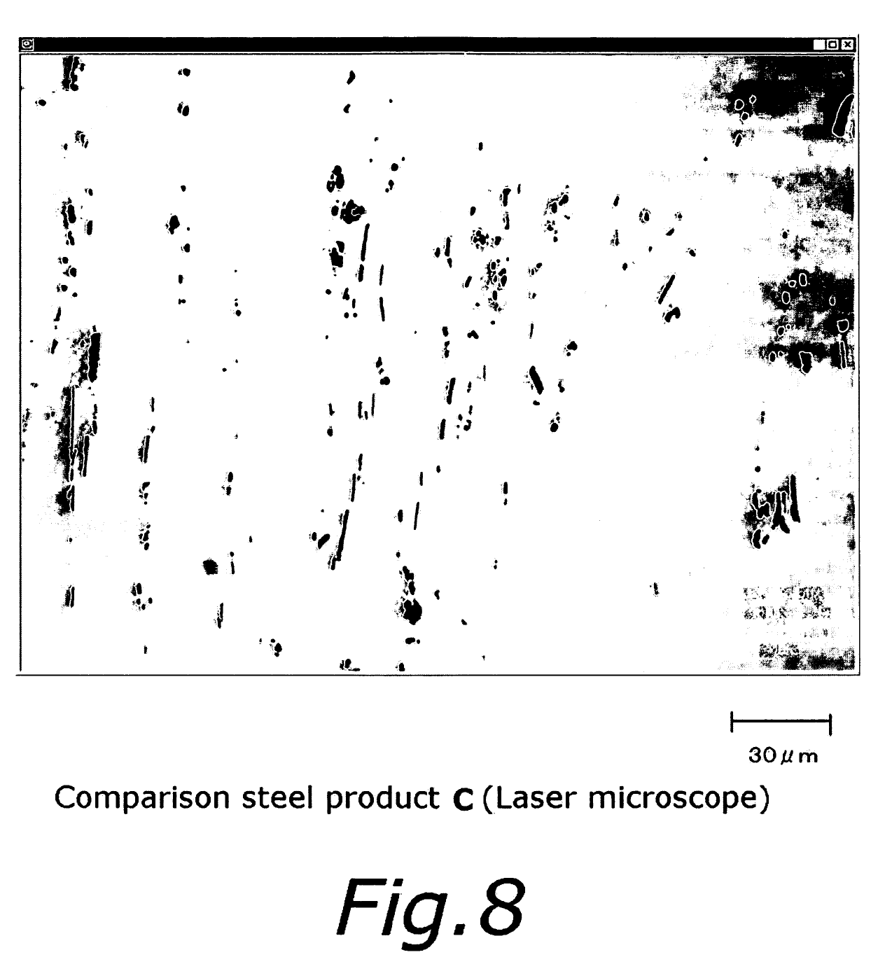

The rotor 2 formed by being machined from a round bar is cut in the direction parallel to the rolling direction, and the mirror-ground cut section of each stainless steel product (invention steel product A, comparison steel product B and comparison steel product C) was observed under laser microscope (×100, ×500). FIGS. 3 to 8 show the result of this observation. As understood from this observation result, inclusions appearing as black spots on the invention steel product A (FIG. 3) and the comparison steel product C (FIG. 7) are finely and uniformly distributed. A further detailed observation (FIGS. 4 and 8) shows that most of the inclusions are not longer than 20 μm in the rolling direction. Each inclusion mixed in the comparison steel product B (FIG. 5), on the other hand, is large, uneven, extended long in the rolling direction (vertical direction in FIGS. 3 to 8) and about 40 to 50 μm long or sometimes about 150 μm long. The inclusions, processed by surface passivation using an acid solvent, are melted and form voids. In the case where a member is thin along the rolling direction, therefore, elongate voids formed in the rolling direction extend through the product and poses the problem of leakage of an oil constituting the lubricating fluid. Thus, the comparison steel product B is found to be not very suitable as a stainless steel product for the members of the fluid dynamic bearing device, and the length along the rolling direction of the inclusions has an upper limit.

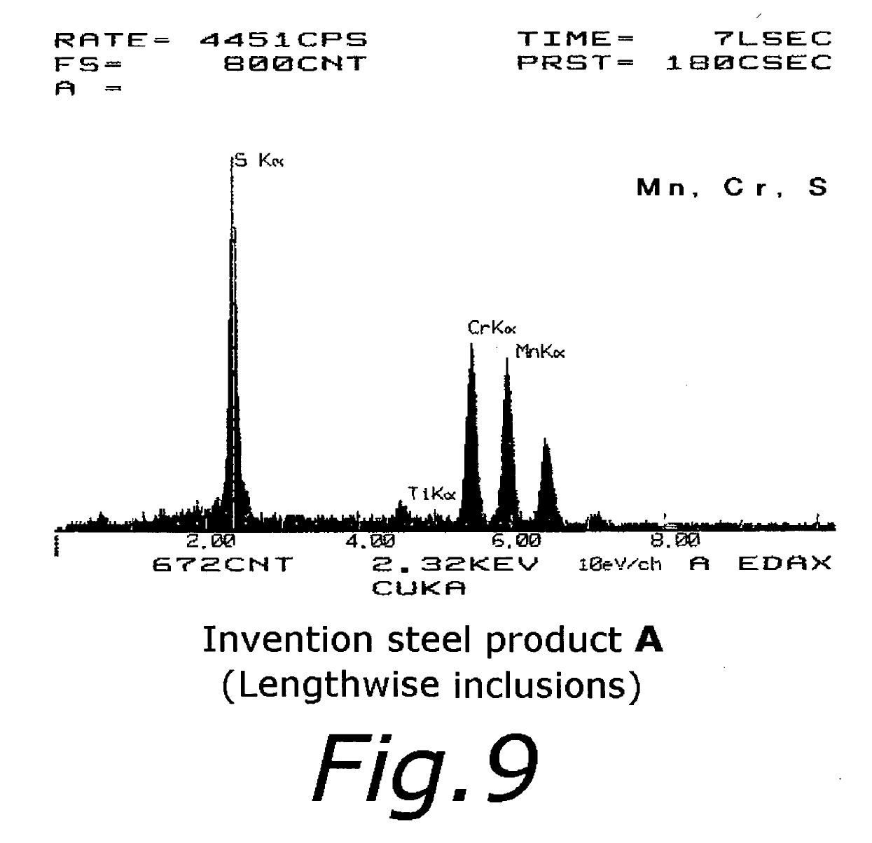

The result of analysis (measured at an acceleration voltage of 20 kV) of the component elements of each inclusion appearing as black spots on the cross section of each stainless steel product in FIGS. 3 to 8 is shown in FIGS. 9 to 12.

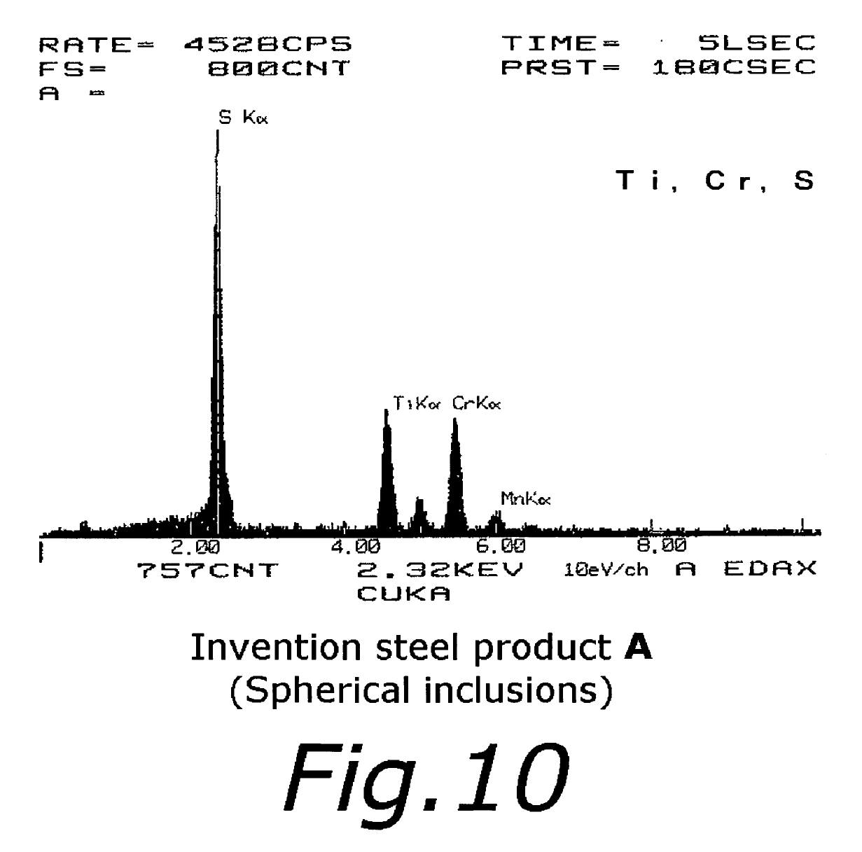

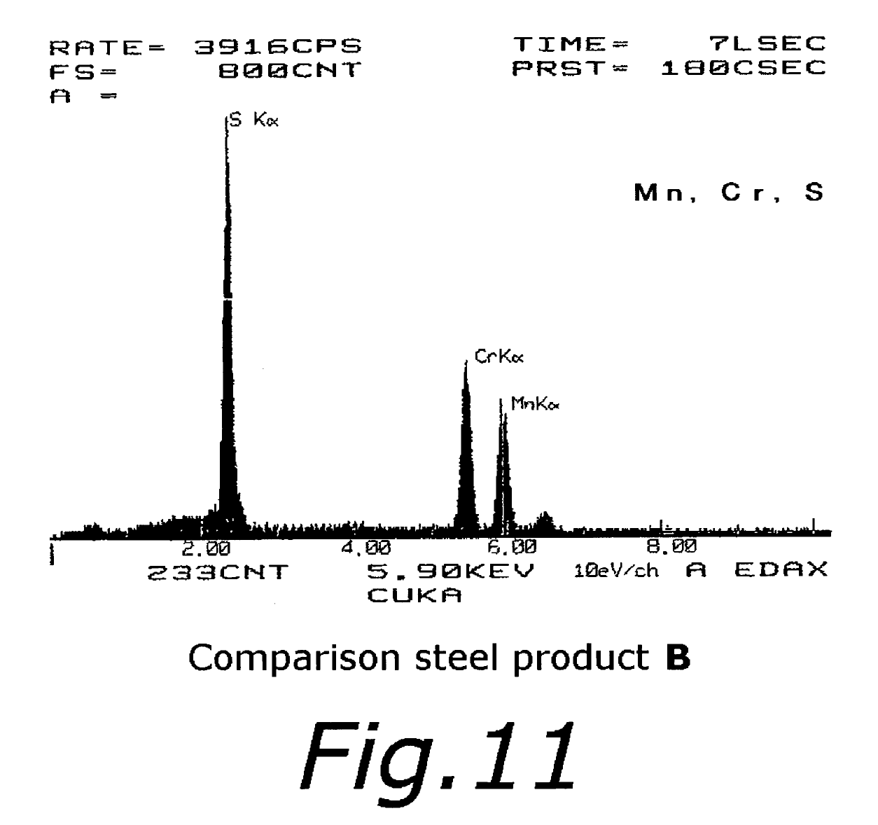

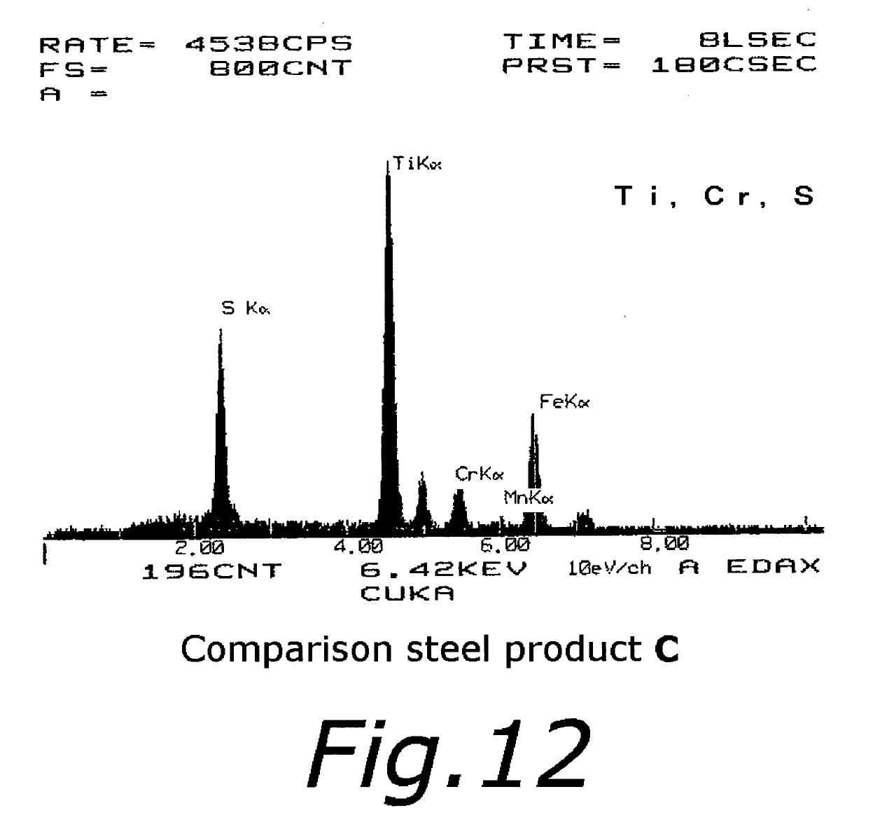

It is understood that in the invention steel product A, the fine and elongate inclusion somewhat extending in the rolling direction in FIG. 9 and the fine spherical inclusion shown in FIG. 10 contain different elements. As indicated by the result of element analysis, the inclusion elongate in the direction of rolling of the invention steel product A (FIG. 9) and the comparison steel product B (FIG. 11) have substantially the same main elements (Mn (manganese), Cr (chromium) and S (sulfur)). The elongate inclusion of the invention steel product A (FIG. 9), however, contains a slight amount of Ti (titanium), and each particle size of the Mn—Cr—S inclusion of the invention steel product A is smaller in both area and length. This is considered the result of the Ti content. The spherical inclusion of the invention steel product A (FIG. 10), on the other hand, has the main component elements of Ti, Cr and S. The comparison steel product C (FIG. 12), although containing spherical inclusions having the main component elements of Ti and S, contains only a very small amount of Cr. Also, S is smaller in peak than Cr, indicating that a considerable part of Cr is fixed in the form of other than sulfide.

To form the inclusion of this type in the steel member, the composition of the steel member is required to be properly selected. The elements S, Ti and Mn are especially important.

The elements T and Mn both form an inclusion particle by being combined with S. In the case where Ti and Mn are added in such an amount as to fix the entire S in steel, however, Cr no longer forms a sulfide, and the inclusion particles containing Ti, Cr, S or Mn, Cr, S as main component elements fail to be formed. One mol Ti is considered to combine with 0.5 mol S, while one mol Mn is considered to combine with one mol S to form an inclusion. To form an inclusion such as the invention steel product A, therefore, the mol ratio (0.5 Ti+Mn)/S<1.0 is desirable. In the case where Ti and Mn are too small in amount, on the other hand, the steel quality is deteriorated. Therefore, the lower limit of 0.5<(0.5 Ti+Mn)/S is required to be met. Since the element Ti forms TiN, the portion forming TiN fails to contribute to the formation of a sulfide. In calculating (0.5 Ti+Mn)/S, Ti fixed in the form of TiN by N is required to be subtracted in advance.

The three types of steel shown in Table 1 assume the following values, respectively, of (0.5 Ti+Mn)/S.

Invention steel product A: (0.5 Ti+Mn)/S=0.77

Comparison steel product B: (0.5 Ti+Mn)/S=1.17

Comparison steel product C: (0.5 Ti+Mn)/S=2.12

Stainless steel contains 11% or more Cr. In the case where the extraneous element S which cannot be combined with Ti or Mn is combined with Cr to make up an inclusion thereby contributing to an improved machinability.

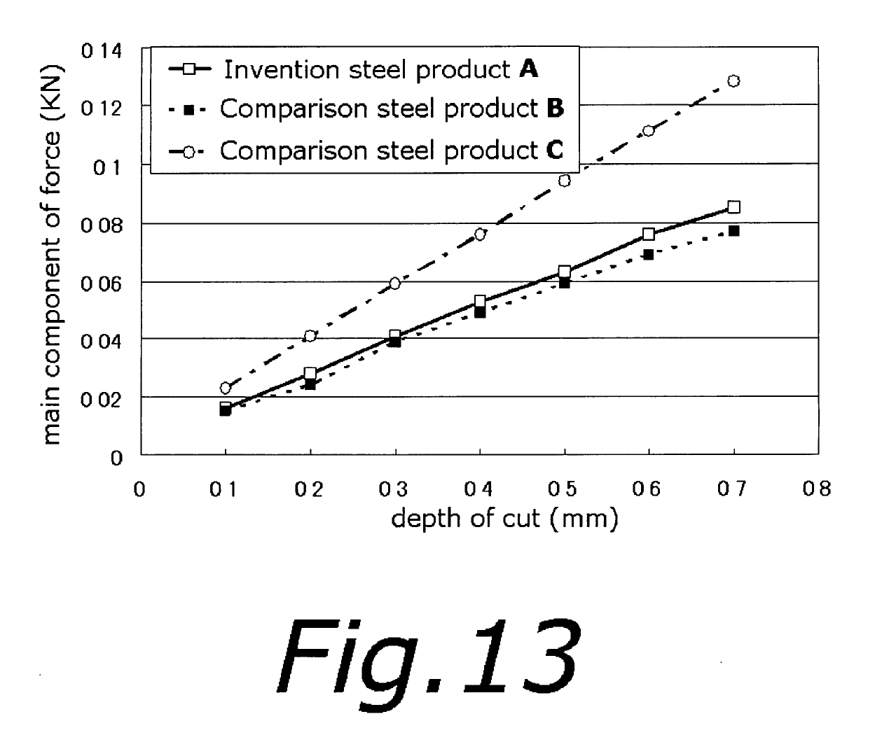

Next, in order to determine the machinability required to form the fluid dynamic bearing device, the machinability of stainless steel was evaluated. In the evaluation method shown in FIG. 13, the cutting resistance of the cutting edge of a cutting tool is measured to determine the relation between the depth of cut (bite) and the resistance value. With regard to the invention steel product A and the comparison steel product B with the inclusions containing Mn (manganese), Cr (chromium) and S (sulfur) long in the rolling direction, as compared with the comparison steel product C with the inclusions having only fine spherical particles containing Ti (titanium) Cr (chromium) and S (sulfur), the resistance value is not increased with the depth of cut, and therefore a satisfactory machinability is exhibited. On the other hand, the comparison steel product C containing only fine inclusions increases in resistance value in proportion to the depth of cut, and therefore provides no suitable steel material for the members requiring a highly accurate machinability such as a small-sized fluid dynamic bearing device. This indicates that at least a certain amount of inclusions of not less than a predetermined size (length along the rolling direction) is required.

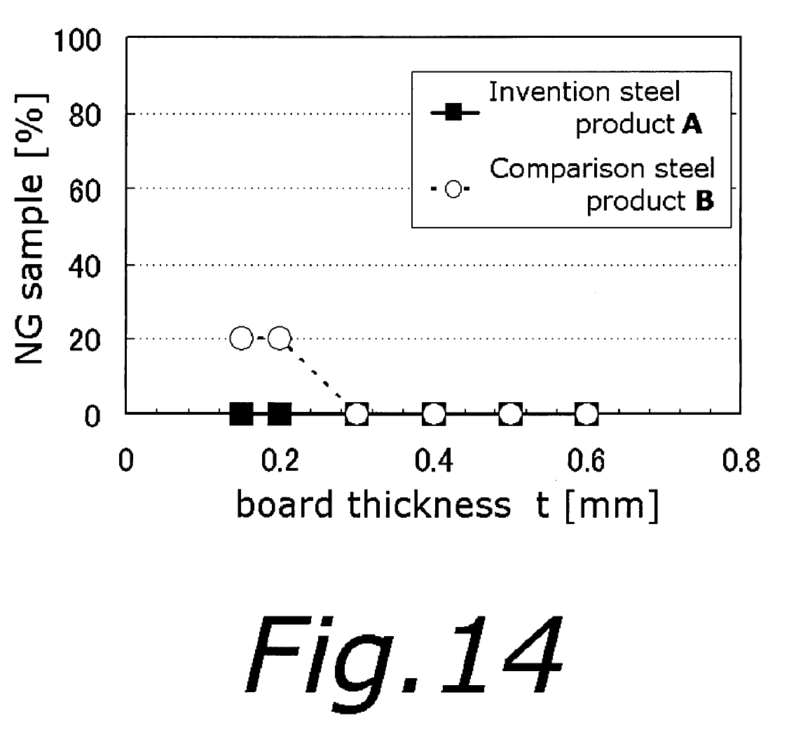

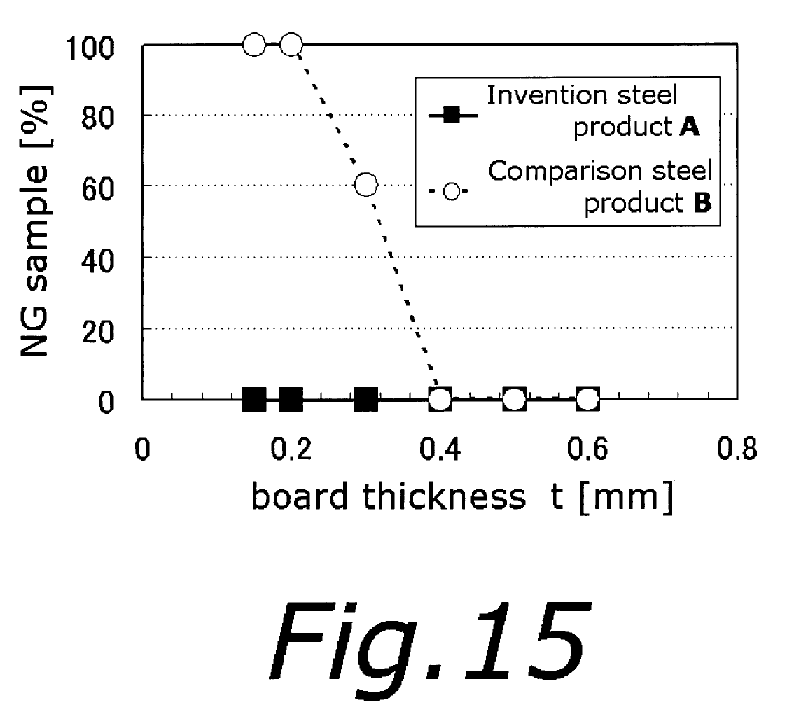

Further, a helium leak test was conducted to determine the limit of leakage of the lubricating fluid for the members further reduced in size and used for the fluid dynamic bearing device. In this test, the helium (He) gas pressure is applied to the invention steel product A and the comparison steel product B of various thickness along the rolling direction and having a satisfactory machinability, and by measuring the penetration of the gas, the possibility of the lubricating fluid not leaking was determined. The helium leak test was conducted by the spray method for measurement. With SUS303 as a standard, the samples with an increased detection peak indicating the helium gas leak were counted as nonconforming samples. The stainless steel members of the invention steel product A and the comparison steel product B were cut in the direction perpendicular to the rolling direction and the probability of occurrence of nonconforming samples was measured for the thickness of 0.15 mm to 0.60 mm. The result is shown in FIGS. 14 and 15.

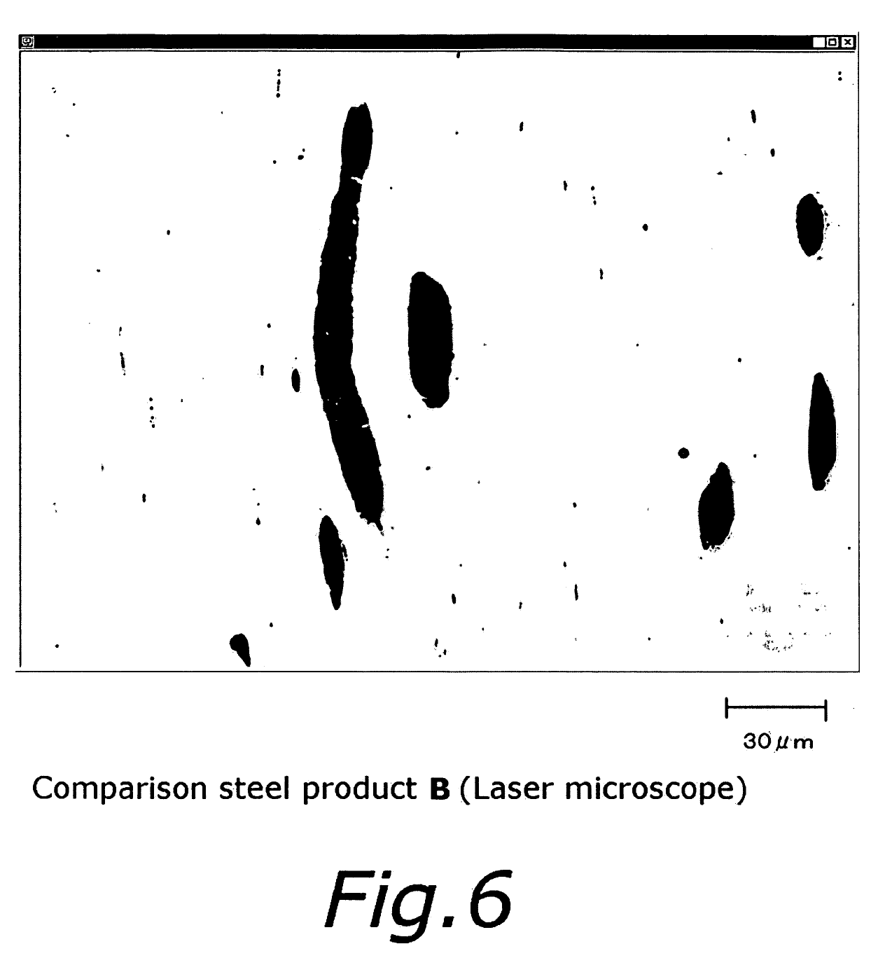

FIG. 14 is a graph showing the result of observation of the helium gas leak for the invention steel product A and the comparison steel product B not processed (with inclusions still existing in stainless steel), and FIG. 15 a graph showing the result of observing the helium gas leak of the invention steel product A and the comparison steel product B after surface passivation (with the inclusions melted out from stainless steel) using an acid solvent. The graph indicates that as for the comparison steel product B not processed, some leakage is detected from the thickness of 0.2 mm for a deteriorated reliability. With regard to the comparison steel product B subjected to surface passivation, in contrast, the leakage starts with the thickness of 0.3 mm and full leakage occurs for the thickness of not more than 0.2 mm. This leak is considered to be caused by the fact that the inclusions existing in the comparison steel product B is elongate in the rolling direction as shown in FIG. 6.

The invention steel product A, however, develops no leak at all for the thickness of between 0.6 mm and 0.15 mm inclusive, and the result remains unchanged after surface passivation. The invention steel product A of course develops no leak for the thickness of more than 0.6 mm. This indicates that the size and rate of inclusions for the invention steel product A causes no lubricating fluid leakage problem even when the inclusions exude after surface chemical treatment.

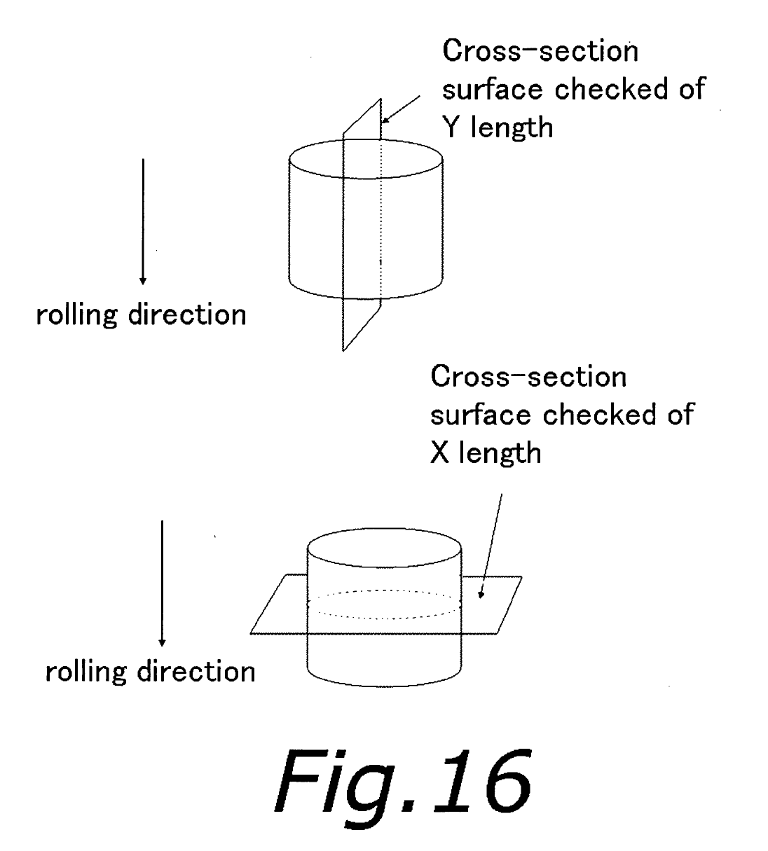

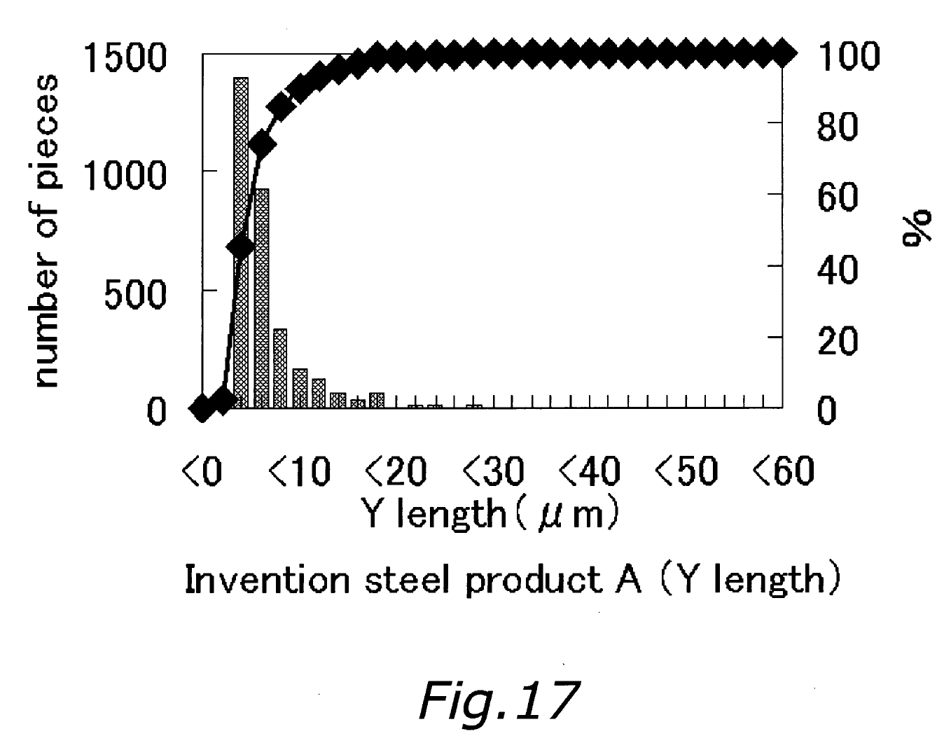

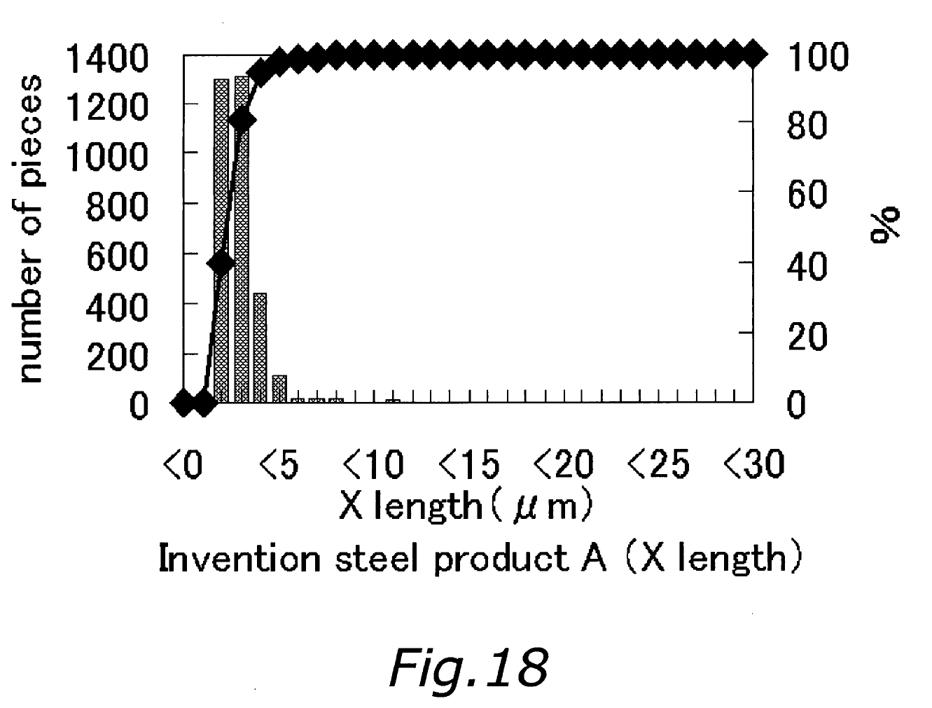

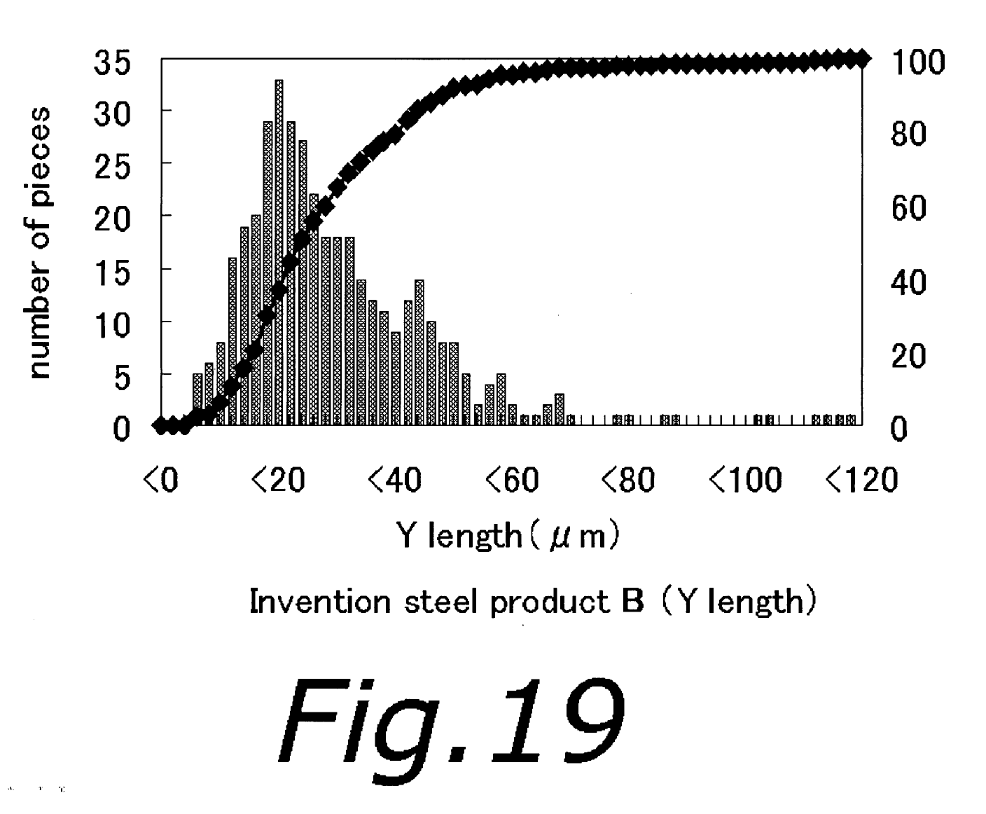

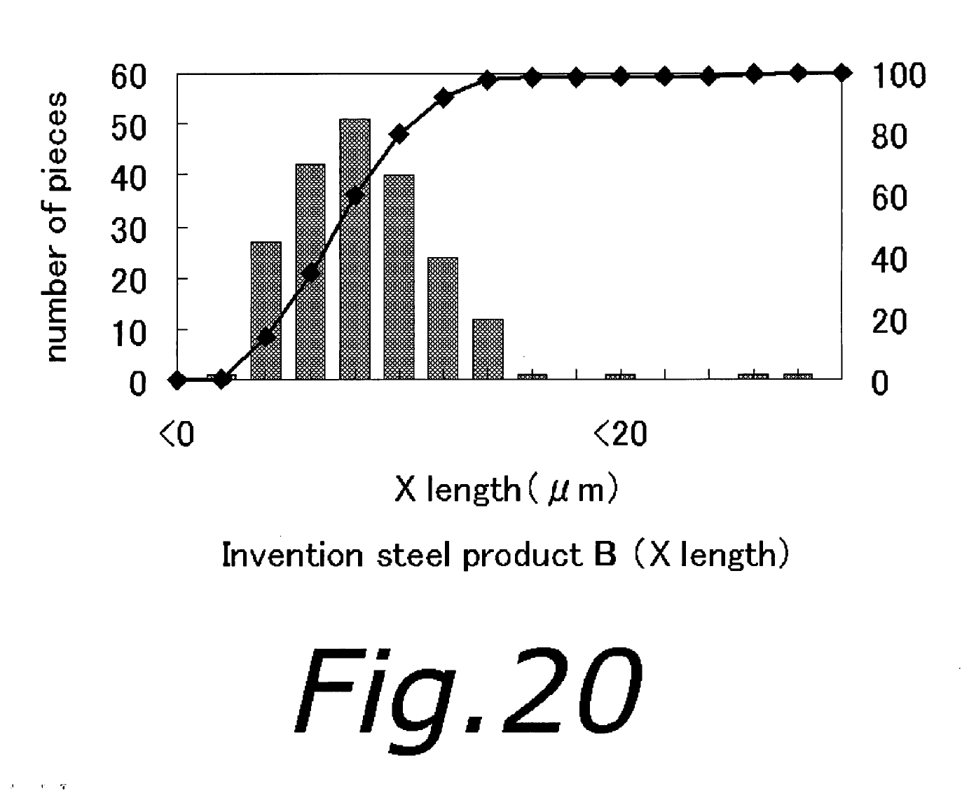

Finally, the size of the inclusion affecting the machinability was studied in detail. FIG. 16 is a diagram showing a method of measuring the size and length of the inclusion existing in the stainless steel of the invention steel product A and the comparison steel product B. In measurement, the invention steel product A and the comparison steel product B are cut in two directions (Y along the length in rolling direction and X along the width in the direction perpendicular to the rolling direction), and the resulting cross section was mirror ground. After grinding, the length of the inclusion visible on the ground surface was observed and measured under laser microscope. The inclusions visible in two screens each about 1 mm² in the visual field were observed for each steel material. The result is shown in FIGS. 17 to 20.

It is understood that for the invention steel product A, inclusions are existent in the range of about 2 to 28 μm in Y direction, or especially, concentrated for the length of 4 to 8 μm, while in X direction, inclusions are concentrated in the range of about 2 to 11 μm, or especially, with the width of 2 to 3 μm. The maximum length in Y direction of the invention steel product A is 81 μm probably because several inclusions are connected along the rolling direction. The probability of this long inclusion existing along the rolling direction is less than 1%. In the case of a steel material such as the invention steel product A having fine inclusions, however, the maximum length is not more than 100 μm even inclusions are connected, and therefore no lubricating fluid leaks even for a member small in thickness along the rolling direction. With regard to the comparison steel product B, on the other hand, inclusions exist over the length of 6 to 118 μm in Y direction and over the length of about 2 to 28 μm in X direction. In addition, the size of inclusions is uneven and the inclusions are distributed more widely than for the invention steel product A.

This indicates that the inclusions existing in the stainless steel suitable for the members to use with the fluid dynamic bearing device are 2 to 30 μm long in rolling direction (Y direction), 2 to 8 μm wide in the direction (X direction) perpendicular to the rolling direction, or more preferably, 2 to 10 μm long in the rolling direction (Y direction) and 2 to 4 μm wide in the direction (X direction) perpendicular to the rolling direction.

Based on these observation results for the invention steel product A and the comparison steel product B, Table 2 shows the number of inclusions existing in each area of 1 mm², the maximum length of inclusions in the rolling direction (Y direction), the average length of inclusions in the rolling direction (Y direction), the maximum width of inclusions in the direction (X direction) perpendicular to the rolling direction, the average width of inclusions in the direction (X direction) perpendicular to the rolling direction, and the aspect ratio (length in rolling direction (Y direction)/average length in the direction (X direction) perpendicular to the rolling direction).

TABLE 2

| | Number of | Maximum | Average | Maximum | Maximum | Aspect |
|---|---|---|---|---|---|---|
| | pieces/mm2 | length (μm) | length (μm) | breadth (μm) | breadth (μm) | ratio |
| Invention steel | 1409.21 | 81.25 | 5.24 | 10.42 | 1.97 | 2.66 |
| product A | | | | | | |
| Comparison | 81.14 | 115.63 | 28.31 | 26.04 | 7.25 | 3.90 |
| steel product B | | | | | | |

Thus, a member suitable for the fluid dynamic bearing device causing no leakage of the lubricating fluid and capable of easy machining operation requires inclusions in the number of 100 to 2500 per mm² based on the number of inclusions for the comparison steel product B, or preferably 1000 to 2000 per mm² based on the number of inclusions for the invention steel product A, or 1 to 20%, or preferably, 1 to 5% of the grinding surface. Also, the length along the rolling direction of each inclusion is required to be not more than 100 μm (maximum length of the invention steel product A) and the width along the direction perpendicular to the rolling direction of the inclusion is required to be not more than 15 μm (maximum width of the invention steel product A). The length in the rolling direction of each inclusion exceeding 100 μm would cause the leakage of the lubricating fluid as in the comparison steel product B. Also, the average length of each inclusion in the rolling direction, based on the length distribution in the rolling direction (Y direction) for the invention steel product A, is required to be 1 to 30 μm, or preferably, in the range of 1 to 10 μm where the length distribution in the rolling direction (Y direction) for the invention steel product A is concentrated, and at the same time, the average width of inclusions in the direction perpendicular to the rolling direction, based on the average length distribution in the direction (X direction) perpendicular to the rolling direction for the invention steel product A, is required to be 1 to 10 μm, or preferably in the range of 1 to 5 μm where the average length in the direction (X direction) perpendicular to the rolling direction for the invention steel product A is concentrated. Also, the average aspect ratio (length in the rolling direction/average length in the direction perpendicular to the rolling direction) of each inclusion, as apparent from Table 2, is required to be not more than 3. Further, the average area of the inclusions is required to be not more than 100 μm², or preferably, 50 μm².

The average value of the maximum diameter of the inclusions existing in the cross section in the rolling direction of a member used for the fluid dynamic bearing device is not more than one tenth of the thickness in the rolling direction of the cross section. Specifically, the value “average maximum diameter in the rolling direction of inclusions/thickness of the member in the rolling direction” is preferably not more than one tenth. This is due to the fact that according to this embodiment (invention steel product A), no leakage of the helium gas is detected even for the length of 30 μm² in the rolling direction of the inclusion particles with the thickness of 0.3 mm (thickness for which nonconforming samples are confirmed from the comparison steel product B by the helium leak test).

Further, as confirmed in FIGS. 14 and 15, according to this invention (invention steel product A), no lubricating fluid leaks even for the maximum thickness of 0.1 mm. In view of the requirement that the average value of the maximum diameter in the rolling direction is not more than one tenth of the thickness of the cross section in the rolling direction, the average value of the maximum diameter of inclusions in the rolling direction is more preferably not more than 10 μm.

The result described above shows that a dynamic fluid bearing device hardly causing oil leakage can be realized by using the stainless steel having inclusions like the invention steel product A. Especially, the invention is suitably applicable to a small-sized dynamic bearing device used for a miniature motor.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A fluid dynamic bearing device comprising:
a fixed member having a bearing face;
a rotary member having a bearing face, relatively rotatable to the fixed member, the bearing face of the fixed member and the bearing face of the rotary member being confronting each other with a minute gap therebetween;
dynamic pressure generating grooves formed on at least one of the bearing face of the fixed member and the bearing face of the rotary member; and
lubricating fluid with which the minute gap is filled; wherein:
at least one of the fixed member and the rotary member comprises a free-cutting stainless steel member; and
the free-cutting stainless steel member includes inclusion particles having, on a cross section thereof parallel to a rolling direction of the steel,
a distribution density of not less than 100 and not more than 2500 inclusive per mm²,
a short diameter of each particle of not more than 15 μm,
the average short diameter of not less than 1 μm and not more than 10 μm inclusive,
the long diameter of each particle of not more than 100 μm, and
the average long diameter of not less than 1 μm and not more then 30 μm inclusive.

2. A fluid dynamic bearing device comprising:
a fixed member having a bearing face;
a rotary member having a bearing face, relatively rotatable to the fixed member, the bearing face of the fixed member and the bearing face of the rotary member being confronting each other with a minute gap therebetween;
dynamic pressure generating grooves formed on at least one of the bearing face of the fixed member and the bearing face of the rotary member; and
lubricating fluid with which the minute gap is filled; wherein:
at least one of the fixed member and the rotary member comprises a free-cutting stainless steel member; and
the free-cutting stainless steel member includes inclusion particles having, on a cross section thereof parallel to a rolling direction of the steel,
a long diameter of each particle of not more then 30 μm,
a total cross sectional areas of not less than 1% and not more than 20% inclusive of the area of the cross section,
the short diameter of not more than 15 μm, the average short diameter of not less than 1 μm and not more than 10 μm inclusive,
the long diameter of each particle of not more than 100 μm, and
the average long diameter of not less than 1 μm and not more than 30 μm inclusive.

3. A fluid dynamic bearing device comprising:
a fixed member having a bearing face;
a rotary member having a bearing face, relatively rotatable to the fixed member, the bearing face of the fixed member and the bearing face of the rotary member being confronting each other with a minute gap therebetween;
dynamic pressure generating grooves formed on at least one of the bearing face of the fixed member and the bearing face of the rotary member; and
lubricating fluid with which the minute gap is filled; wherein:
at least one of the fixed member and the rotary member comprises a free-cutting stainless steel member; and
the free-cutting stainless steel member contains, by weight percentage,
C of 0.01 to 0.04%,
Si of 0.50 to 1.50%,
Mn of 0.10 to 0.60%,
S of 0.20 to 0.50% and
Ti of 0.10 to 0.60%; and
the free-cutting stainless steel further contains inclusion particles made of sulfide.

4. A fluid dynamic bearing device comprising:
a fixed member having a bearing face;
a rotary member having a bearing face, relatively rotatable to the fixed member, the bearing face of the fixed member and the bearing face of the rotary member being confronting each other with a minute gap therebetween;
dynamic pressure generating grooves formed on at least one of the bearing face of the fixed member and the bearing face of the rotary member; and
lubricating fluid with which the minute gap is filled; wherein:
at least one of the fixed member and the rotary member comprises a free-cutting stainless steel member; and
the free-cutting stainless steel member contains, by weight percentage,
C of 0.01 to 0.04%,
Si of 0.50 to 1.50% and
Mn of 0.10 to 0.60%; and
the free-cutting stainless steel further contains inclusion particles containing Ti, Cr and S as main component elements.

5. A fluid dynamic bearing device according to claim 2, wherein
the free-cutting stainless steel member contains, by weight percentage,
C of 0.01 to 0.04%,
Si of 0.50 to 1.50% and
Mn of 0.10 to 0.60%; and
the free-cutting stainless steel member further contains inclusion particles containing Ti, Cr and S as main component elements.

6. A fluid dynamic bearing device comprising:
a fixed member having a bearing face;
a rotary member having a bearing face, relatively rotatable to the fixed member, the bearing face of the fixed member and the bearing face of the rotary member being confronting each other with a minute gap therebetween;
dynamic pressure generating grooves formed on at least one of the bearing face of the fixed member and the bearing face of the rotary member; and
lubricating fluid with which the minute gap is filled; wherein:
at least one of the fixed member and the rotary member comprises a free-cutting stainless steel member; and
the free-cutting stainless steel member contains, by weight percentage,
C of 0.01 to 0.04%,
Si of 0.50 to 1.50% and
Ti of 0.10 to 0.60%; and
the free-cutting stainless steel member further contains inclusion particles containing Mn, Cr and S as main component elements.

7. A fluid dynamic bearing device according to claim 2, wherein:
the free-cutting stainless steel member contains, by weight percentage,
C of 0.01 to 0.04%,
Si of 0.50 to 1.50% and
Ti of 0.10 to 0.60%; and
the free-cutting stainless steel further member contains inclusion particles containing Mn, Cr and S as main component elements.

8. A fluid dynamic bearing device according to claim 3,
wherein the free-cutting stainless steel member further contains inclusion particles containing Mn, Cr and S as main component elements.

9. A fluid dynamic bearing device according to claim 4,
wherein the free-cutting stainless steel member further contains inclusion particles containing Mn, Cr and S as main component elements.

10. A fluid dynamic bearing device according to claim 5,
wherein the free-cutting stainless steel member further contains inclusion particles containing Mn, Cr and S as main component elements.

11. A fluid dynamic bearing device according to claim 3,
wherein the free-cutting stainless steel member further contains inclusion particles containing Ti, Cr and S as main component elements.

12. A fluid dynamic bearing device according to claim 6,
wherein the free-cutting stainless steel member further contains inclusion particles containing Ti, Cr and S as main component elements.

13. A fluid dynamic bearing device according to claim 7,
wherein the free-cutting stainless steel member further contains inclusion particles containing Ti, Cr and S as main component elements.

14. A fluid dynamic bearing device according to claim 8,
wherein the free-cutting stainless steel member further contains inclusion particles containing Ti, Cr and S as main component elements.

15. A fluid dynamic bearing device according to claim 1,
wherein the free-cutting stainless steel member contains, by weight percentage, Cr of 19 to 24%.

16. A fluid dynamic bearing device according to claim 2,
wherein the free-cutting stainless steel member contains, by weight percentage, Cr of 19 to 24%.

17. A fluid dynamic bearing device according to claim 3,
wherein the free-cutting stainless steel member contains, by weight percentage, Cr of 19 to 24%.

18. A fluid dynamic bearing device according to claim 10,
wherein the free-cutting stainless steel member contains, by weight percentage, Cr of 19 to 24%.

19. A fluid dynamic bearing device according to claim 13,
wherein the free-cutting stainless steel member contains, by weight percentage, Cr of 19 to 24%.

20. A fluid dynamic bearing device according to claim 14,
wherein the free-cutting stainless steel member contains, by weight percentage, Cr of 19 to 24%.

21. A fluid dynamic bearing device according to claim 3, wherein the free-cutting stainless steel member is generated by the process including the steps of:
casting melted steel with the composition thereof regulated and producing an ingot;
extending the ingot in one direction by at least selected one of hot forging and hot rolling thereby to produce a rod member; and
cutting the rod member thereby to produce the free-cutting stainless steel member.

22. A fluid dynamic bearing device according to claim 10, wherein the free-cutting stainless steel member is generated by the process including the steps of:
casting melted steel with the composition thereof regulated and producing an ingot;
extending the ingot in one direction by at least selected one of hot forging and hot rolling thereby to produce a rod member; and
cutting the rod member thereby to produce the free-cutting stainless steel member.

23. A fluid dynamic bearing device according to claim 13, wherein the free-cutting stainless steel member is generated by the process including the steps of:
casting melted steel with the composition thereof regulated and producing an ingot;
extending the ingot in one direction by at least selected one of hot forging and hot rolling thereby to produce a rod member; and
cutting the rod member thereby to produce the free-cutting stainless steel member.

24. A fluid dynamic bearing device according to claim 14, wherein the free-cutting stainless steel member is generated by the process including the steps of:
casting melted steel with the composition thereof regulated and producing an ingot;
extending the ingot in one direction by at least selected one of hot forging and hot rolling thereby to produce a rod member; and
cutting the rod member thereby to produce the free-cutting stainless steel member.

25. A fluid dynamic bearing device according to claim 21,
wherein the total elongation percentage through the entire process including the ingot producing step to the rod member producing step is not less than 60.

26. A fluid dynamic bearing device according to claim 22,
wherein the total elongation percentage through the entire process including the ingot producing step to the rod member producing step is not less than 60.

27. A fluid dynamic bearing device according to claim 23,
wherein the total elongation percentage through the entire process including the ingot producing step to the rod member producing step is not less than 60.

28. A fluid dynamic bearing device according to claim 24,
wherein the total elongation percentage through the entire process including the ingot producing step to the rod member producing step is not less than 60.

29. A fluid dynamic bearing device according to claim 3,
wherein the average diameter of inclusion particles along the rolling direction measured on the cross section of the free-cutting stainless steel member along the rolling direction is not more than one tenth of the thickness of free-cutting stainless steel member measured along the rolling direction.

30. A fluid dynamic bearing device according to claim 10,
wherein the average diameter of inclusion particles along the rolling direction measured on the cross section of the free-cutting stainless steel member along the rolling direction is not more than one tenth of the thickness of free-cutting stainless steel member measured along the rolling direction.

31. A fluid dynamic bearing device according to claim 13,
wherein the average diameter of inclusion particles along the rolling direction measured on the cross section of the free-cutting stainless steel member along the rolling direction is not more than one tenth of the thickness of free-cutting stainless steel member measured along the rolling direction.

32. A fluid dynamic bearing device according to claim 14,
wherein the average diameter of inclusion particles along the rolling direction measured on the cross section of the free-cutting stainless steel member along the rolling direction is not more than one tenth of the thickness of free-cutting stainless steel member measured along the rolling direction.

33. A fluid dynamic bearing device according to claim 25,
wherein the average diameter of inclusion particles along the rolling direction measured on the cross section of the free-cutting stainless steel member along the rolling direction is not more than one tenth of the thickness of free-cutting stainless steel member measured along the rolling direction.

34. A fluid dynamic bearing device according to claim 3,
wherein at least a portion of the free-cutting stainless steel member is formed by cutting and the thickness of the portion measured along the rolling direction is not less than 0.1 mm and not more than 10 mm.

35. A fluid dynamic bearing device according to claim 10,
wherein at least a portion of the free-cutting stainless steel member is formed by cutting and the thickness of the portion measured along the rolling direction is not less than 0.1 mm and not more than 10 mm.

36. A fluid dynamic bearing device according to claim 13,
wherein the average diameter of inclusion particles along the rolling direction measured on the cross section of the free-cutting stainless steel member along the rolling direction is not more than one tenth of the thickness of free-cutting stainless steel member measured along the rolling direction.

37. A fluid dynamic bearing device according to claim 14,
wherein the average diameter of inclusion particles along the rolling direction measured on the cross section of the free-cutting stainless steel member along the rolling direction is not more than one tenth of the thickness of free-cutting stainless steel member measured along the rolling direction.

38. A fluid dynamic bearing device according to claim 19,
wherein the average diameter of inclusion particles along the rolling direction measured on the cross section of the free-cutting stainless steel member along the rolling direction is not more than one tenth of the thickness of free-cutting stainless steel member measured along the rolling direction.

39. A fluid dynamic bearing device according to claim 33,
wherein the average diameter of inclusion particles along the rolling direction measured on the cross section of the free-cutting stainless steel member along the rolling direction is not more than one tenth of the thickness of free-cutting stainless steel member measured along the rolling direction.

40. A spindle motor comprising:
a fluid dynamic bearing device according to claim 14;
a hub made from the free-cutting stainless steel, which is supported by the fluid dynamic bearing device and adapted to carry a recording disk thereon; and
a rotary drive mechanism for rotationally driving the hub.

41. A spindle motor comprising:
a fluid dynamic bearing device according to claim 28;
a hub made from the free-cutting stainless steel, which is supported by the fluid dynamic bearing device and adapted to carry a recording disk thereon; and
a rotary drive mechanism for rotationally driving the hub.

42. A spindle motor comprising:
a fluid dynamic bearing device according to claim 32;
a hub made from the free-cutting stainless steel, which is supported by the fluid dynamic bearing device and adapted to carry a recording disk thereon; and
a rotary drive mechanism for rotationally driving the hub.
